(19) United States
(12) Patent Application Publication
(10) Pub. No.: US 2003/0107852 A1
(43) Pub. Date: Jun. 12, 2003

(54) Electrochemical capacitor having low internal resistance

(76) Inventor: Zheng Chen, Dublin, OH (US)

Correspondence Address: John L. Isaac. Esq., Isaac & Associates, Suite 900, 143 Union Blvd., Lakewood, CO, 80228-1829, US

(21) Appl. No.: 10/014,876

(22) Filed: Dec. 11, 2001

(51) Int. Cl. H02H 7/16

(52) U.S. Cl. 361/15

(57) ABSTRACT

A capacitor is disclosed which includes at least one electrochemical cell. The cell includes a cathode having a coating of an amorphous metal oxide, an anode having a coating of an amorphous metal oxide and a substrate layer containing an electrolyte disposed between the cathode and anode. A conductive rubber layer is positioned on the exterior surface of both the cathode and the anode, and first and second current collectors are disposed, respectively, adjacent the outer surfaces of the conductive rubber layers. Finally, a metallic coating is interposed between each rubber layer and its adjacent current collector to reduce the contact resistance present in the capacitor.

### BACKGROUND OF THE INVENTION

1. Field of the Invention

The present invention relates generally to rechargeable electrochemical capacitors and, more particularly, to electrochemical capacitors having low internal resistance and high charge/discharge rates. Specifically, the present invention relates to improved capacitors comprised of one or more electrochemical cells fabricated without the use of high-pressure containment elements.

2. Description of the Prior Art

Electrochemical capacitors are devices which store electrical energy at the interface between an ionically-conducting electrolyte phase and an electronically-conducting electrode material. Electrochemical capacitors are a class of high rate energy storage devices which use such electrolytes and electrodes of various kinds in a system similar to that of conventional batteries. The electrochemical capacitors, like batteries, are essentially energy storage devices. However, unlike batteries, capacitors rely on charge accumulation at the electrolyte/electrode interface to store energy. Charge storage in electrochemical capacitors therefore is a surface phenomena. Conversely, charge storage in batteries is a bulk phenomena occurring within the bulk of the electrode material.

Electrochemical capacitors can generally be divided into one of two subcategories. Double layer capacitors involved those in which the interfacial capacitance at the electrode/electrolyte interface can be modeled as two parallel sheets of charge. Pseudocapacitor devices, on the other hand, are those in which charge transfer between the electrolyte and the electrode occurs over a wide potential range and is the result of primary, secondary, and tertiary oxidation/reduction reactions between the electrode and the electrolyte. These types of electrochemical capacitors are currently being developed for high pulse power applications such as in cellular telephones.

Most of the known electrochemical capacitor active materials for both cathode and anode structures are based on metallic elements such as platinum, iridium, ruthenium, or cobalt. These materials are generally quite expensive and pose a significant hurdle to the widespread commercialization of this technology. Moreover, electrochemical capacitor devices have also suffered from problems associated with the manufacture and packaging of such devices. It is the nature of electrochemical capacitors to require relatively small packages which preferably develop high pulse power spikes and require high charge/discharge rates. Prior techniques of assembling such devices typically increased the thickness of the device as well as the complexity of the manufacturing process. Increased complexity resulted in manufacturing defects which caused yield losses. Moreover, as the capacitor package became thicker due to processing, the introduction of electrode equivalence series resistance (ESR), in other words internal resistance, reduced the efficiencies of the fabricated devices as well as decreased the charge/discharge rates.

One previous approach to this problem was to fabricate the capacitor by placing the cell or series of cells which made up the capacitor under high physical pressure. While this increased compression approach to fabrication reduced the internal resistance in the device, it created by a whole new set of fabrication problems. Therefore, there remains a need to provide electrochemical capacitor devices which feature low internal resistance, thin profiles and high charge/discharge rates without the inherent problems associated with high pressure containers and compression fabrication techniques. The present invention addresses this significant problem.

### SUMMARY OF THE INVENTION

Accordingly, it is one object of the present invention to provide an improved capacitor device.

It is another object of the present invention to provide a capacitor having low internal resistance and high charge/discharge rates.

Yet another object of the present invention is to provide a capacitor structure and fabrication which yields efficient capacitor output without requiring a high pressure packing for the device.

Still another object of the present invention is to provide a capacitor device capable of various size dimensions unrelated to pressure considerations.

To achieve the foregoing and other objects and in accordance with the purpose of the present invention, as embodied and broadly described herein, a capacitor is disclosed which includes at least one electrochemical cell. The cell includes a cathode having a coating of an amorphous metal oxide, an anode having a coating of an amorphous metal oxide and a substrate layer containing an electrolyte disposed between the cathode and anode. A conductive rubber layer is positioned on the exterior surface of both the cathode and the anode, and first and second current collectors are disposed, respectively, adjacent the outer surfaces of the conductive rubber layers. Finally, a metallic coating is interposed between each rubber layer and its adjacent current collector to reduce the contact resistance present in the capacitor.

In one modification of the invention, the amorphous metal oxide of both the anode and cathode is selected from oxides of the group consisting of ruthenium, iridium, cobalt, nickel, molybdenum, tungsten, manganese, titanium, tantalum and zinc, the preferred metal oxide being amorphous hydrated ruthenium oxide. In another modification, the metallic coating between each rubber layer and its adjacent current collector is approximately 0.0025-0.1000 mm thick with the metallic coating being selected from at least one metal of the group consisting of Ag, Cu, stainless steel, Al, Ti, Ni, Au, Pt, Ta and alloys thereof. Still another modification utilizes a liquid electrolyte, preferably sulfuric acid.

In still another modification of the invention, a capacitor is disclosed having a plurality of stacked electrochemical cells. Each cell includes a pair of electrodes having amorphous metal oxide therein with the electrodes being separated by an electrolyte layer. The stack of cells has first and second ends surfaces, and a conductive rubber layer is interposed between adjacent stacked electrochemical cells. A pair of conductive rubber end layers cover, respectively, the first and second end surfaces of the stacked electrochemical cells, while first and second current collectors are disposed, respectively, proximately adjacent the pair of conductive rubber end layers. Finally, a metallic coating is interposed between each of the current collectors and its respectively adjacent conductive rubber end layer.

### BRIEF DESCRIPTION OF THE DRAWINGS

The accompanying drawings which are incorporated in and form a part of the specification illustrate preferred embodiments of the present invention and, together with a description, serve to explain the principles of the invention. In the drawings:

FIG. 1 is a side sectional view of a capacitor constructed in accordance with certain previously known fabrication techniques utilizing compression to reduce internal cell resistance;

FIG. 2 is a side sectional view of a capacitor constructed in accordance with the present invention and illustrating one electrochemical cell therein; and

FIG. 3 is a side sectional view of a capacitor constructed in accordance with the present invention and illustrating a plurality of electrochemical cells therein.

### DETAILED DESCRIPTION OF THE PREFERRED EMBODIMENTS

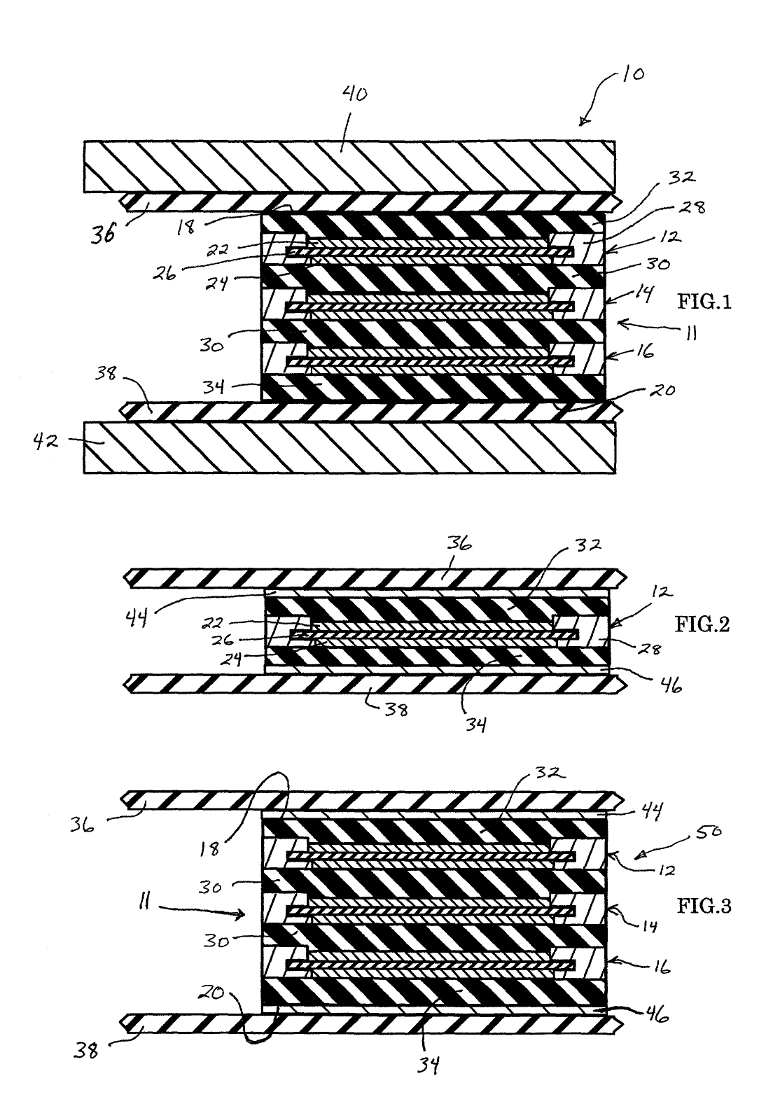

Referring now to FIG. 1, a capacitor 10 is illustrated utilizing the known the prior art technique of applying pressure to the capacitor cells during both fabrication and storage in order to ensure good interparticle contact within the capacitor cells so as to minimize internal resistance therewithin. The capacitor 10 preferably includes a stack 11 having a plurality of individual electrochemical cells 12, 14 and 16 arranged in a stacked alignment. The stack of cells II include an upper end surface 18 and a lower end surface 20. Each cell 12, 14 and 16 is constructed in a similar manner and includes an anode 22 and a cathode 24 separated by a separator 26 soaked with electrolyte. In preferred form, the anode 22, cathode 24 and electrolyte layer 26 are are arranged within an insulator ring 28. The cells 12, 14 and 16 are in turn separated from each other by a plurality of conductive rubber elements 30. Finally, an upper conductive rubber element 32 and a lower conductive rubber element 34 form the end surfaces 18, 20, respectively.

In a more conventional arrangement, the upper and surface 18 and the lower end surface 20 of the stack of cells 11 are respectively contacted by current collectors 36, 38. Containment plates 40, 42 are then disposed on the outer surfaces of each of the current collectors 36, 38. The containment plates 40, 42 are arranged to compress the cells 12, 14 and 16 therebetween in order to create sufficient pressure to ensure good interparticle contact and thereby minimize internal resistance within the capacitor 10.

Referring now to FIG. 2, a single electrochemical cell 12 is constructed similar to that of the previously described cell 12 of FIG. 1. More particularly, both the cathode 24 and anode 22 structures are preferably made from oxides of various metals and specifically ruthenium, iridium, cobalt, nickel, molybdenum, tungsten, manganese, titanium, tantalum and zinc. In preferred form, both the anode 22 and cathode 24 structures are made from amorphous hydrated ruthenium oxide. The anode and cathode 22, 24 are separated by an electrolyte layer 26. In preferred form, the electrolyte layer 26 includes a substrate containing a liquid electrolyte, most preferably sulfuric acid. The circular ends of the anode 22, cathode 24 and electrolyte soaked separator 26 are sealed by an insulator ring 28.

As in the prior embodiments, both surfaces of the electrochemical cell 12, that is the exterior surfaces of the ends of the anode 22 and the cathode 24, are covered by a conductive rubber element 32, 34, respectively. The conductive rubber element in preferred form includes a composite structure having natural rubber and carbon powder and/or fiber therein. A metallic coating or layer 44 is deposited onto the exterior surface of the conductive rubber element 32, while a similar metallic coating or layer 46 is deposited onto the exterior or outer surface of the conductive rubber element 34. In this manner, the metallic coatings 44, 46 are interposed between the conductive rubber elements 32, 34 and the current collectors 36, 38 proximate thereto. In preferred form, the metallic coatings 44, 46 comprise a thin layer, most preferably 0.0025-0.100 mm in thickness, of a metal designed as an intermediate layer between the terminal and the conductive rubber to reduce contact resistance and subsequent internal cell resistance. In preferred form, the metallic coatings 44, 46 are selected from any appropriate metal such as Ag, Cu, stainless steel, Al, Ti, Ni, Au, Pt, Ta and alloys thereof such as Inconel. The metallic coating layers 44, 46 do not directly contact the corrosive electrolyte layer 26 and are separated from the electrolyte by the conductive rubber layers 32, 34, respectively. Most preferably, the metallic coatings 44, 46 are made from Ag due to the combination of performance and cost.

Referring now to FIG. 3, the capacitor 50 illustrated therein is substantially similar to the structure illustrated in FIG. 2 only that it includes a plurality of electrochemical cells 12, 14 and 16 similar to that of FIG. 1. The individual electrochemical cells 12, 14 and 16 are constructed in the same manner as that discussed and illustrated in detail for the cell 12 of FIG. 2 and are separated from each other by conductive rubber layers 30, as in the capacitor 10 of FIG. 1. In this particular embodiment, the uppermost layer 18 and the lowermost layer 20 of the stack 11 of cells 12, 14 and 16 are covered by the metallic coatings 44, 46 as in FIG. 2. In this manner, the metallic coatings 44, 46 are interposed between between the stack 11 and the current collectors 36, 38. This arrangement obviates the need for the containment plates 40, 42 as used in the embodiment of FIG. 1. The reason that the plates 40, 42 are not required for the capacitor 50 structure is that the pressure or compression exerted thereby is not necessary to achieve low internal resistance as well as high charge/discharge rates for the capacitor 50 as a result of the additional metallic layers 44, 46. The interposed metallic coatings 44, 46 and the conductive rubbers 30, 32 and 34 further increase the powder density of the capacitor 50.

### EXAMPLE I

To test the above, two capacitors were constructed each containing six electrochemical cells as described above. The first capacitor was constructed in accordance with the arrangement illustrated in FIG. 1 and has a construction of the capacitor 10 thereof. The second capacitor also containing six cells was constructed in accordance with the embodiment illustrated in FIG. 3 and has a construction of the capacitor 50 thereof. Thus, the only difference between these two capacitors was the fact that the second capacitor included the disclosed metallic coatings between the stack of electrochemical cells and the respective current collectors, while the first capacitor did not include such metallic layers and instead included containment plates for exerting pressure on the stack of electrochemical cells. The containment plates of the first capacitor were constructed so as to create pressure of approximately 201 psi, while the pressure exerted on the stack of cells of the second capacitor was less than 2 psi. The capacitance exhibited by both cells was the same, that of 200 mF. However, the ESR measurements for both of the capacitors were significantly different. The ESR of the first capacitor utilizing pressure and containment plates was 72 mohm, while the ESR of the second capacitor constructed in accordance with the present invention was almost one-third that of the first capacitor, i.e. 27 mohm. Clearly, then, the construction of the present invention simplified the fabrication of the cathode of the invention while providing significantly less contact and internal resistance.

As can be seen from the above, the present invention provides for a capacitor structure and device which does not require high pressure or compression as part of the fabrication technique or containment arrangement. Nonetheless, the capacitor of the present invention provides a device having significant capacitance capability and high charge/discharge rates while providing significantly lower contact resistance and internal resistance therewithin. This provides for higher efficiency and longer life-times for the capacitor constructed in accordance with a present invention.

The foregoing description and the illustrative embodiments of the present invention have been described in detail in varying modifications and alternate embodiments. It should be understood, however, that the foregoing description of the present invention is exemplary only, and that the scope of the present invention is to be limited to the claims as interpreted in view of the prior art. Moreover, the invention illustratively disclosed herein suitably may be practiced in the absence of any element which is not specifically disclosed herein.

I claim:

1. A capacitor comprising:
a cathode having a coating of an amorphous metal oxide;
an anode having a coating of an amorphous metal oxide;
an substrate layer containing an electrolyte disposed between said cathode and anode;
a conductive rubber layer disposed on the exterior surface of each said cathode and anode;
first and second current collectors disposed, respectively, adjacent the outer surfaces of said conductive rubber layers; and
a metallic coating interposed between each said rubber layer and its adjacent current collector to reduce the contact resistance present in said capacitor.

2. The capacitor as claimed in claim 1, wherein said metal oxide is selected from oxides of the group consisting of ruthenium, iridium, cobalt, nickel, molybdenum, tungsten, manganese, titanium, tantalum and zinc.

3. The capacitor as claimed in claim 2, wherein said metal oxide comprises ruthenium oxide.

4. The capacitor as claimed in claim 3, wherein said metal oxide comprises amorphous hydrated ruthenium oxide.

5. The capacitor as claimed in claim 1, wherein said metallic coating is approximately 0.0025-0.1000 mm thick.

6. The capacitor as claimed in claim 1, wherein said metallic coating is selected from at least one metal of the group consisting of Ag, Cu, stainless steel, Al, Ti, Ni, Au, Pt, Ta and alloys thereof.

7. The capacitor as claimed in claim 1, wherein said electrolyte is a liquid.

8. The capacitor as claimed in claim 7, wherein said electrolyte comprises sulfuric acid.

9. A capacitor comprising:
a plurality of stacked electrochemical cells each said cell including a pair of electrodes having amorphous metal oxide therein with said electrodes being separated by an electrolyte soaked layer, said stack of cells having first and second end surfaces;
a conductive rubber layer interposed between adjacent stacked electrochemical cells;
a pair of conductive rubber end layers covering, respectively, said first and second end surfaces of said stacked electrochemical cells;
first and second current collectors disposed, respectively, proximately adjacent said pair of conductive rubber end layers; and
a metallic coating interposed between each said current collector and its respectively adjacent conductive rubber end layer.

10. The capacitor as claimed in claim 9, wherein said electrolyte of each said cell comprises a liquid soaked substrate layer.

11. The capacitor as claimed in claim 10, wherein said liquid electrolyte comprises sulfuric acid.

12. The capacitor as claimed in claim 9, wherein said metallic coating is layered onto each of said conductive rubber end layers.

13. The capacitor as claimed in claim 9, wherein said metallic oxide is selected from oxides of the group consisting of ruthenium, iridium, cobalt, nickel, molybdenum, tungsten, manganese, titanium, tantalum and zinc.

14. The capacitor as claimed in claim 13, wherein said metallic oxide comprises ruthenium oxide.

15. The capacitor as claimed in claim 9, wherein said metallic coating is approximately 0.0025-0.01000 mm thick and is selected from the group consisting of Ag, Cu, stainless steel, Al, Ti, Ni, Au, Pt, Ta and alloys thereof.

16. A capacitor having low internal resistance and fast charge/discharge rate, said capacitor comprising:
a plurality of electrochemical cells stacked on top of each other with a conductive rubber layer interposed between each stacked cell, said stack of cells having an upper and a lower end surface;
each said cell including a cathode having a coating of an amorphous metal oxide, an anode having a coating of an amorphous metal oxide, and an electrolyte-soaked substrate layer disposed between said cathode and anode;
conductive rubber end layers covering, respectively, said upper and lower end surfaces of said stacked electrochemical cells;
first and second current collectors disposed, respectively, proximate said pair of conductive rubber end layers; and
a metallic coating disposed on each said conductive rubber end layer between said end layer and its adjacent current collector.

17. The capacitor as claimed in claim 16, wherein each said conductive rubber layer comprises a composite of carbon powder, carbon fibers and natural rubber.

18. The capacitor as claimed in claim 16, wherein said electrolyte comprises sulfuric acid.

19. The capacitor as claimed in claim 16, wherein said metallic coating is approximately 0.0025-0.1000 mm thick and is selected from the group consisting of Ag, Cu, stainless steel, Al, Ti, Ni, Au, Pt, Ta and alloys thereof.

20. The capacitor as claimed in claim 16, wherein said metal oxide comprises amorphous hydrated ruthenium oxide.
